(19) United States
(12) Patent Application Publication
(10) Pub. No.: US 2024/0163792 A1
(43) Pub. Date: May 16, 2024

(54) EXTENDING TWT INFORMATION FRAME FUNCTIONALITY OPERATION AND SIGNALING FOR ENHANCED LOW LATENCY AND POWER SAVINGS

(71) Applicant: Qualcomm Incorporated, San Diego, CA (US)

(72) Inventors: Abdel Karim AJAMI, San Diego, CA (US); Abhishek Pramod Patil, San Diego, CA (US); Yongchun Xiao, Fremont, CA (US); Alfred Asterjadhi, San Diego, CA (US); George Cherian, San Diego, CA (US); Sai Yiu Duncan Ho, San Diego, CA (US); Yanjun Sun, San Diego, CA (US); Gaurang Naik, San Diego, CA (US)

(21) Appl. No.: 18/504,979

(22) Filed: Nov. 8, 2023

Related U.S. Application Data
(60) Provisional application No. 63/383,483, filed on Nov. 12, 2022.

(51) Int. Cl. H04W 52/02

(52) U.S. Cl. CPC H04W 52/0216

(57) ABSTRACT

This disclosure provides methods, components, devices and systems for extending target wake time (TWT) frame functionality. Some aspects more specifically relate to accommodating TWT wake intervals that do not satisfy threshold TWT wake intervals. In some examples, a first wireless communication device configures at least one of: one or more subfields of a field or one or more fields of an element that include TWT information in a TWT frame, where the subfield(s) or field(s) indicate a presence or absence of at least one optional field in the TWT frame, or an optional element in the TWT frame. The device then transmits the TWT frame to a second wireless communication device. After the second device receives this TWT frame, this device executes one or more operations associated with a TWT schedule or service period based at least in part on the configured subfield(s) or field(s) or the configured optional element.

### PRIORITY INFORMATION

The present Application for Patent claims priority under 35 U.S.C. § 119 to U.S. Provisional Patent Application No. 63/383,483, filed Nov. 12, 2022 and entitled “EXTENDING TWT INFORMATION FRAME FUNCTIONALITY OPERATION AND SIGNALING FOR ENHANCED LOW LATENCY AND POWER SAVINGS,” which is assigned to the assignee hereof and hereby expressly incorporated by reference herein.

### TECHNICAL FIELD

This disclosure relates generally to wireless communication, and more specifically, to extending target wake time (TWT) frame functionality, operation, and signaling for enhanced low latency and power savings.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

One innovative aspect of the subject matter described in this disclosure can be implemented in a first wireless communication device. The first wireless communication device includes one or more memories, and one or more processors each communicatively coupled with at least one of the one or more memories. The one or more processors, individually or in combination, are configured to cause the first wireless communication device to configure at least one of: one or more subfields of a field, or one or more fields of an element, that include target wake time (TWT) information in a TWT frame, where the one or more subfields or the one or more fields indicate a presence or an absence of at least one optional field in the TWT frame, or an optional element in the TWT frame. In some examples, the one or more processors, individually or in combination, are further configured to transmit the TWT frame to a second wireless communication device.

In another innovative aspect, a first wireless communication device includes one or more memories, and one or more processors each communicatively coupled with at least one of the one or more memories. The one or more processors, individually or in combination, are configured to cause the first wireless communication device to receive, from a second wireless communication device, a TWT frame configured with at least one of: one or more subfields of a field, or one or more fields of an element, that include TWT information in the TWT frame, where the one or more subfields or the one or more fields indicate a presence or an absence of at least one optional field in the TWT frame, or an optional element in the TWT frame. In some examples, the one or more processors, individually or in combination, are further configured to execute one or more operations associated with a TWT schedule or a TWT service period (SP) based at least in part on the one or more subfields or the one or more fields indicating the presence or the absence of the at least one optional field, or the optional element.

Another innovative aspect of the subject matter described in this disclosure can be implemented in a method for wireless communication performable at a first wireless communication device. The method includes configuring at least one of: one or more subfields of a field, or one or more fields of an element, that include TWT information in a TWT frame, where the one or more subfields or the one or more fields indicate a presence or an absence of at least one optional field in the TWT frame, or an optional element in the TWT frame. In some examples, the method further includes transmitting the TWT frame to a second wireless communication device.

In another innovative aspect, a method for wireless communication performable at a first wireless communication device includes receiving, from a second wireless communication device, a TWT frame configured with at least one of: one or more subfields of a field, or one or more fields of an element, that include TWT information in the TWT frame, wherein the one or more subfields or the one or more fields indicate a presence or an absence of at least one optional field in the TWT frame, or an optional element in the TWT frame. In some examples, the method further includes executing one or more operations associated with a TWT schedule or a TWT SP based at least in part on the one or more subfields or the one or more fields indicating the presence or the absence of the at least one optional field, or the optional element.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2A shows a TWT information frame, in accordance with various aspects of the present disclosure.

FIG. 2B shows a TWT information field, in accordance with various aspects of the present disclosure.

FIG. 3A shows a TWT setup frame, in accordance with various aspects of the present disclosure.

FIG. 3B shows a TWT element format including various field and sub-field formats, in accordance with various aspects of the present disclosure.

FIG. 3C shows a timing diagram for TWT element transmissions, in accordance with various aspects of the present disclosure.

FIG. 4 shows a flowchart illustrating an example process performable by a wireless access point (AP) that supports extending at least TWT information frame functionality, operation, and signaling for enhanced low latency and power savings.

FIG. 5 shows a flowchart illustrating an example process performable by a wireless station (STA) that supports extending at least TWT information frame functionality, operation, and signaling for enhanced low latency and power savings.

FIG. 6 shows a block diagram of an example wireless communication device that supports extending at least TWT information frame functionality, operation, and signaling for enhanced low latency and power savings.

FIG. 7 shows a block diagram of another example wireless communication device that supports extending at least TWT information frame functionality, operation, and signaling for enhanced low latency and power savings.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to wireless communication and more particularly to extending target wake time (TWT) frame functionality, including at least TWT information frames. Some aspects relate generally to accommodating TWT wake intervals that do not satisfy threshold TWT wake intervals. Various aspects specifically relate to configuring one or more subfields of a field (or one or more fields of an element) that include TWT information in a TWT frame, such that these subfield(s) or field(s) indicate a presence or absence of at least one optional field or optional element in the TWT frame. Some aspects also specifically relate to configuring the at least one optional field or the optional element in the TWT frame. In some examples, the at least one optional field or optional element may be a multi-link operation (MLO) information element which indicates a link between two wireless communication devices (e.g., access points (APs), stations (STAs), and the like) to which TWT information in the TWT frame applies. Such TWT information may include, for example, an indication of a suspension or resumption of a TWT schedule on the link, an indication of an early termination of a TWT service period (SP) scheduled on the link, a TWT schedule identifier or other TWT identifier, TWT timing information, broadcast or restricted TWT traffic information, or the like. In some examples, the at least one optional field or optional element when present may indicate a suspension or a resumption of a TWT SP scheduled on a link between the two wireless communication devices. In some examples, the at least one optional field or optional element may indicate a traffic identifier (TID) or a stream classification service identifier (SCSID) associated with a TWT SP scheduled on a link between two wireless communication devices. In some examples, the at least one optional field or optional element may indicate an end of traffic delivery for one or more TIDs associated with a TWT SP.

In various aspects, a field or element that includes TWT information may be, for example, a TWT information field, a TWT element, an additional or extended TWT information field or element, a TWT information extension field or element, or other field or element associated with a TWT. Likewise, a TWT frame including such TWT information may be, for example, a TWT information frame, a TWT setup frame, a TWT teardown frame, a TWT request frame, a TWT response frame, or other frame associated with a TWT. Moreover, an “optional field” or “optional element” respectively refers to a field or element (e.g., multiple fields) that is permissible, but may not be required, in a TWT frame such as a TWT information frame (e.g., per the IEEE standard), and/or a field or element that is not required for a device to transmit, receive, decode, and/or interpret a TWT frame. For example, if one or more subfields of a TWT information field in a TWT information frame, or if one or more fields of a TWT element in a different TWT frame, indicate a presence of at least one optional field or optional element, then the optional field(s) or element are included in the corresponding TWT frame. On the other hand, if the one or more subfields or the one or more fields indicate an absence of the at least one optional field or optional element, then the optional field(s) or element are not included in the corresponding TWT frame.

Particular aspects of the subject matter described in this disclosure can be implemented to realize one or more of the following potential advantages. In some examples, by configuring at least one optional field or optional element in a TWT frame, or by configuring one or more fields or subfields indicating a presence or an absence of the at least one optional field or optional element in a TWT frame, the described techniques can be used to signal additional information, such as link identifiers, traffic flow identifiers for different TWT agreements, and the like in the extended or additional field(s). By indicating such TWT information, one or more operations associated with a TWT schedule or a TWT SP, such as suspension, resumption, or early termination of a TWT schedule, of a TWT SP, in association with one or more TIDs, or the like, may be performed by a wireless communication device receiving the TWT frame. Additionally, the described techniques allow for the TWT frame to include an MLO information element that indicates the link to which the TWT information in the TWT frame applies, that allows for the TWT frame to be sent when a wireless communication device (e.g., AP, STA, and the like) or a link between wireless communication devices is in an active mode, and that further allows for early termination of a TWT SP or a termination of a TWT SP before a configured time. By allowing for such optional field(s) or element(s) to be configured or indicated when present, TWT-related operations may be facilitated (e.g., suspension or resumption of different TWT SPs, TIDs associated with different TWT SPs, and early termination of a TWT SP), resource allocation may be increased, and power management may be improved.

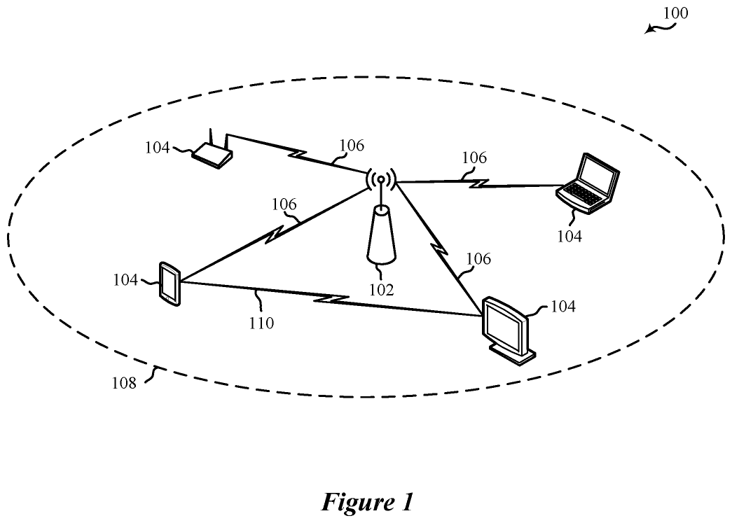

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons may include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also may communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also may communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Some wireless communication devices (including both APs 102 and STAs 104) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

In addition to MLO, Target Wake Time (TWT) has been introduced in the IEEE 802.11ax (Wi-Fi 6) standard as another power-saving feature, which has been further developed and enhanced in subsequent amendments such as IEEE 802.11be (Wi-Fi 7). TWT enables wireless communication devices, such as APs 102 and STAs 104, to negotiate and schedule specific time intervals for data transmission and reception. By doing so, the devices may enter a low-power sleep mode during the periods when no data transmission or reception is scheduled, thereby conserving energy and improving battery life. TWT is particularly beneficial for IoT devices and other battery-powered devices that require efficient power management to prolong their operational lifetime. To facilitate the implementation of TWT, TWT information frames may be used to convey TWT-related information between APs and STAs. These frames may include various fields or elements which provide information for the devices to negotiate, schedule, and manage TWT agreements and wake intervals.

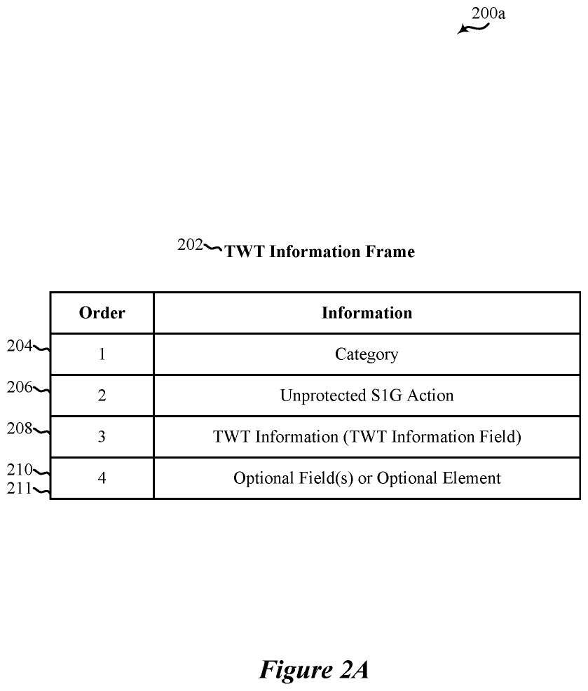

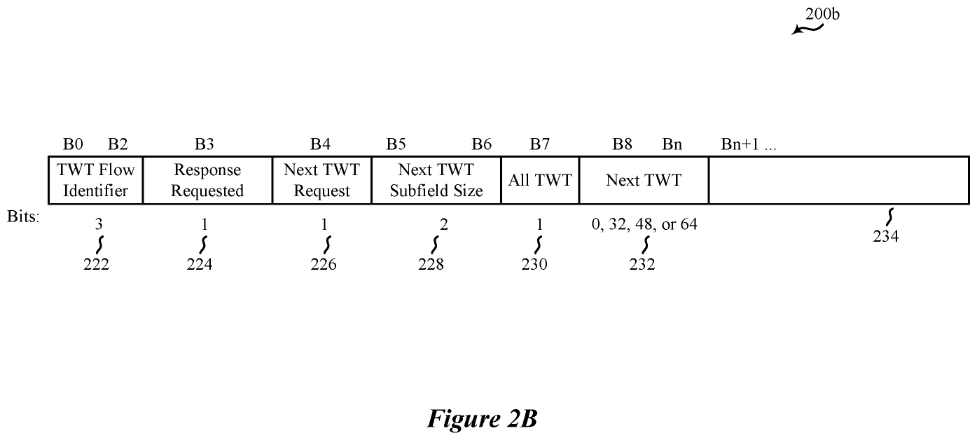

Referring now to FIG. 2A, example 200a shows a TWT information frame 202. The TWT information frame may include multiple fields such as a category field 204, an unprotected (sub-1 GHz) S1G action field 206, and a TWT information field 208. In the techniques described herein, a wireless communication device (e.g., AP, STA, and the like) may also configure the TWT information frame to include at least one optional field 210 or optional element 211. The TWT information frame may include multiple optional fields 210 or optional elements 211. Moreover, to allow for processing a TWT information frame by a wireless communication device including such optional field(s) 210 or optional element(s) 211 in a TWT information frame received by the wireless communication device (e.g., AP, STA, and the like), the techniques described herein further allow for the wireless communication device to indicate a presence of the optional field(s) 210 or optional element(s) 211 in the TWT information frame 202 transmitted to another wireless communication device. Furthermore, the techniques described herein allows the wireless communication device that receives the TWT information frame 202 to process the optional field(s) or optional element(s).

A wireless communication device may configure one or more fields of the TWT information frame 202 or one or more subfields of the TWT information field 208 to indicate the presence of the optional field(s) 210 or optional element(s) 211 in the TWT information frame 202. An example of a format of the TWT information field 208 is shown by example 200b of FIG. 2B. The TWT information field may include multiple subfields, such as a TWT flow identifier subfield 222, a response requested subfield 224, a next TWT request subfield 226, a next TWT subfield size subfield 228, all TWT subfield 230, and next TWT subfield 232. In some implementations, the size of the TWT flow identifier subfield 222 may be 3 bits wide, the size of the response requested subfield 224 may be 1 bit wide, the size of the next TWT request subfield 226 may be 1 bit wide, the size of the next TWT subfield size subfield 228 may be 2 bits wide, the size of the all TWT subfield 230 may be 1 bit wide, and the size of the next TWT subfield 232 may be variable. For example, the size of the next TWT subfield can be 0 bits wide, 32 bits wide, 48 bits wide, or 64 bits wide. In another examples, the sizes of the aforementioned field(s) may be different than that described.

The wireless communication device may configure one or more of the subfields 222, 224, 226, 228, 230, 232 to indicate the presence of the optional field(s) 210 or optional element(s) 211 in the TWT information frame 202. In some implementations, the wireless communication device may configure subfield(s) 224 or 226 to indicate presence of the optional field(s) 210 or optional element(s) 211 in the TWT information frame 202. For example, a value of 0 in subfield 224 or 226 may indicate that the optional field(s) 210 or optional element(s) 211 is/are not present and a value of 1 in subfield 224 or 226 may indicate that the optional field(s) 210 or optional element(s) 211 is/are present. In some implementations, the wireless communication device may configure more than one subfield (e.g., subfields 224 and 226) to indicate presence of the optional field(s) 210 or optional element(s) 211 and additional information, such as information about link identifiers, TWT service periods (SPs), traffic identifiers (TIDs), and the like, that may be included in or more subfields of the field(s) 210/element(s) 211 or one or more fields of an information element indicated or included in the field(s) 210/element(s) 211. For example, if the bits of subfield 224 and 226 have values of “00,” then that may indicate that the optional field(s) 210 or optional element(s) 211 is not present. Similarly if the bits for the subfields 224 and 226 have values of “11,” then it may indicate the presence of the optional field(s) 210 or optional element(s) 211 and presence of a link identifier (ID) bitmap in the optional field(s) 210 or optional element(s) 211. As another example, if the bits for subfields 224 and 226 have values of “10,” then it may indicate the presence of the optional field(s) 210 or optional element(s) 211 and that a link ID bitmap is not present in the optional field(s) 210 or optional element(s) 211 (or may indicate that a link ID information is indicated via 4 bits). In yet another example, if the bits for subfields 224 and 226 have values of “01,” then it may indicate the presence of the optional field(s) 210 or optional element(s) 211 and that the optional field(s) 210 or optional element(s) 211 may include or indicate an information element (e.g., MLO link information element) which may include a link ID bitmap.

In some implementations, the optional field(s) 210/element(s) 211 may extend the TWT information field 208. For example, referring to FIG. 2B, an optional field 210 or optional element 211 may start from bit Bn+1 or subfield 234. In some implementations, the subfield 234 may be one of multiple subfields. In some implementations, one of the subfields 234 may be configured to indicate link ID information, another of the subfields 234 may include a link ID bitmap, and another of the subfields 234 may include a TID bitmap for identifying and/or signaling TIDs of different traffic flows associated with different TWT agreements.

In some implementations, one or more of the subfield(s) 234 may be of different sizes. For example, one of the subfields 234 may be configured to indicate link ID information and may be 4 bits wide. Similarly, another of the subfields 234 may be configured to indicate a link ID bitmap and may be 16 bits (2 octets) wide. In another example, another of the subfields 234 may be configured to indicate a TID bitmap and may be 8 bits (1 octet) wide. Alternatively, they may be different quantities of bits wide.

In some implementations, as described above, the optional field 210/element 211 may include or indicate an information element, such as the MLO link information element in MLO. The information element (e.g., MLO link information element) may include one or more fields which indicate the link between wireless communication devices (e.g., MLDs) to which TWT information in TWT information field 208 applies. The information element may include a link ID bitmap (e.g., the link ID bitmap included in the MLO link identifier information element) which identifies the link.

A wireless communication device (e.g., AP, STA, MLD AP, MLD SP, and the like) may be configured to signal one or more operations associated with one or more TWT schedules on one or more links between the wireless communication device and a second wireless communication device (e.g., AP, STA, MLD AP, MLD SP, and the like), or one or more TWT SPs scheduled on the one or more links, by indicating a corresponding link ID of the one or more links in the optional field 210 or optional element 211 of the TWT information frame 202. Examples of the one or more operations associated with a TWT schedule may include, but are not limited to, suspension of the TWT schedule, resumption of the TWT schedule, and the like. Examples of the one or more operations associated with a TWT SP may include, but are not limited to, early termination of a TWT SP. As described herein, early termination of a TWT SP may refer to suspending the TWT schedule from the time the TWT information frame is transmitted by the wireless communication device until an upcoming TWT SP.

In addition to configuring one or more subfields of TWT information field 208 to indicate the presence of the optional field(s) 210 or the optional element(s) 211, the wireless communication device may configure or indicate in the optional field(s) or the optional element(s) a corresponding link ID(s) of link(s) on which TWT schedules are to be suspended or resumed, or on which TWT SP(s) are to be early terminated.

The wireless communication device may transmit the TWT information frame 202 to a second wireless communication device (e.g., AP, STA, and the like). Based on the indication of a presence of the optional field(s) 210 or the optional element(s) 211, the second wireless communication device may be configured to process the optional field(s) or optional element(s) to decode or identify the link ID information of each link between MLDs and execute a suspension or resumption of a TWT schedule on the respective links. For example, if a TWT schedule is currently not suspended on a link, then the second wireless communication device may be configured to suspend the TWT schedule. Similarly, if the TWT SP is currently suspended on a link, then the second wireless communication device may be configured to resume that TWT schedule. Similarly, if a TWT SP scheduled on the corresponding link of the link ID is not terminated, then the second wireless communication device may be configured to early terminate that TWT SP.

In some implementations, the optional field(s) 210 or the optional element(s) 211 may indicate a suspension or a resumption of TWT schedule(s) or may indicate early termination of a TWT SP. In some implementations, the wireless communication device may signal the suspension or resumption of one or more TWT schedules, or an early termination of a TWT SP, on the same link on which it is communicating with the second wireless communication device. For example, if the wireless communication device and the second wireless communication device are communicating on link 1 (out of multiple links), then the wireless communication device may signal suspension or resumption of one or more TWT SPs on link 1 by indicating link 1 as a link identifier via the optional field(s) 210 or optional element(s) 211. In other implementations, the wireless communication device may signal suspension or resumption of one or more TWT schedules, or an early termination of a TWT SP, on a cross link or a different link from the link on which it is communicating with the second wireless communication device. For example, if the wireless communication device and the second wireless communication device are communicating on link 1, then the wireless communication device may signal suspension or resumption of one or more TWT schedules or early termination of a TWT SP on link 2 by indicating link 2 as a link identifier via the optional field(s) 210 or the optional element(s) 211. In such implementations, the wireless communication device may transmit the TWT information frame 202 on link 1.

Suspending or resuming of TWT schedules or early termination of TWT SPs on different links or cross links may improve the flexibility and functionality of the TWT information frame. Such signaling may be useful when certain channels are restricted, are in a power management mode, or otherwise are associated with different characteristics. For example, early termination of any TWT SPs or suspension or resumption of TWT schedules on a restricted link (e.g., a 3.5 GHz link restricted for incumbents or naval ships), or a power managed mode link (e.g., a link being unavailable due to a doze state or sleep state) can be signaled from a different link (e.g., a non-3.5 GHz link, or a non-restricted link, an awake state link, and the like). Similarly, TWT schedules may be suspended or resumed, or TWT SPs can be early terminated, on a 60 GHz link via a TWT information frame transmitted on a sub-7 GHz link.

In some implementations, the wireless communication device may indicate, via optional field(s) 210 or optional element(s) 211, a TID or a stream classification service identifier (SCSID) associated with a TWT schedule on a link between the wireless communication device and the second wireless communication device. The wireless communication device may also indicate a suspension or a resumption of the TID or SCSID associated with the TWT schedule on the link. The second wireless communication device may suspend or resume the traffic flow associated with TID or the SCSID. The traffic flow may be uplink traffic (e.g., traffic from a STA to an AP), downlink traffic (e.g., traffic from an AP to a STA), or peer-to-peer (P2P) traffic (e.g., from one STA to another STA, from one AP to another AP, and the like). In some implementations, the optional field(s) 210 or the optional element(s) 211 may be for a restricted TWT (R-TWT) agreement, an individual TWT (I-TWT) agreement, a broadcast TWT (B-TWT) agreement, an off-channel TWT agreement, a coordinated TWT agreement, a coordinated off-channel TWT agreement, an extended protocol for a TWT agreement, or a combination of any of the foregoing. For example, the TIDs indicated in the optional field(s) 210 or optional element(s) 211 may be for a coordinated R-TWT agreement. Similarly, the TIDs or the SCSID indicated in the optional field(s) 210 or the optional element(s) 211 may be for a R-TWT agreement based on a stream classification service (SCS) agreement.

The wireless communication device may signal the suspension or resumption of traffic flows corresponding to the TIDs on the same link on which the TWT information frame 202 is transmitted to the second wireless communication device or the same link on which the wireless communication device and the second wireless communication device are communicating. Alternatively, the wireless communication device may signal the suspension or resumption of traffic flows corresponding to the TIDs on the cross link or a different link from the link on which the TWT information frame 202 is transmitted or on which the wireless communication device and the second wireless communication device are communicating.

As described above, the optional field(s) 210 or the optional element(s) 211 may include a TID bitmap. In some implementations, the optional field(s) 210 or the optional element 211 may include an uplink TID bitmap, a downlink TID bitmap, and/or a P2P TID bitmap for the different traffic flows between different wireless communication devices.

In some implementations, a wireless communication device (e.g., a STA) may indicate to a second wireless communication device (e.g., an AP) that all traffic has been delivered. For example, the wireless communication device may indicate, in the optional field(s) 210 or optional element(s) 211, the corresponding TIDs or SCSIDs for the traffic flows that have been delivered to the second wireless communication device. Thus, the wireless communication device may indicate an end of transmissions associated with a TWT SP to the second wireless communication device. In some implementations, the wireless communication device may indicate a request for early termination of the TWT SP via the optional field(s) 210 or optional element(s) 211. The second wireless communication device, based on the indication of the TIDs, SCSIDs, and/or the indication for early termination of the TWT SP may determine whether there is any traffic scheduled from the second wireless communication device to the wireless communication device, and if no traffic is scheduled, then the second wireless communication device may transmit a message indicating a termination of TWT SP prior to a configured end time for the TWT SP. For example, if the second wireless communication device is an AP, and it determines that there is no downlink traffic for the wireless communication device, then the second wireless communication device may transmit a message indicating an early termination of the TWT SP.

As described above, in some implementations, the optional field(s) 210 or the optional element(s) 211 may indicate a link identifier (ID), a traffic identifier (TID), a stream classification service identifier (SCSID), or another parameter associated with a TWT schedule. In such implementations, the optional field(s) or the optional element(s) may be for a restricted TWT (R-TWT) agreement, an individual TWT (I-TWT) agreement, a broadcast TWT (B-TWT) agreement, an off-channel TWT agreement, a coordinated TWT agreement, a coordinated R-TWT agreement, a coordinated I-TWT agreement, a coordinated B-TWT agreement, a coordinated off-channel TWT agreement, an extended protocol for a TWT agreement, or a combination of the foregoing. In some implementations, the optional field(s) or the optional element(s) may be for a single link between the first wireless communication device and the second wireless communication device, or for multiple links respectively between the second wireless communication device and a first multi-link device (MLD) including the first wireless communication device, or for multiple links respectively between the first wireless communication device and a second MLD including the second wireless communication device, or for multiple links respectively between the first MLD and the second MLD. In some implementations, as described above, the wireless communication device may be an access point (AP) or a station (STA), and the second wireless communication device may be another AP or another STA.

In some implementations, a wireless communication device (e.g., STA) may transmit the TWT information frame 202 to the second wireless communication device while the wireless communication device is in power management mode, or while a link between MLDs to which the TWT information frame applies is in a power management mode. For example, the wireless communication device or the link may be in an active power mode (e.g., an awake state) when transmitting the TWT information frame. Similarly, the wireless communication device or the link may be in a power save mode (e.g., a doze state, low power mode, sleep mode, and the like) when transmitting the TWT information frame. If the link is in an active power mode, the wireless communication device may transmit the TWT information frame over the link, while if the link is in a power management mode or a power save mode, the device may transmit the TWT information frame over a different link or cross link.

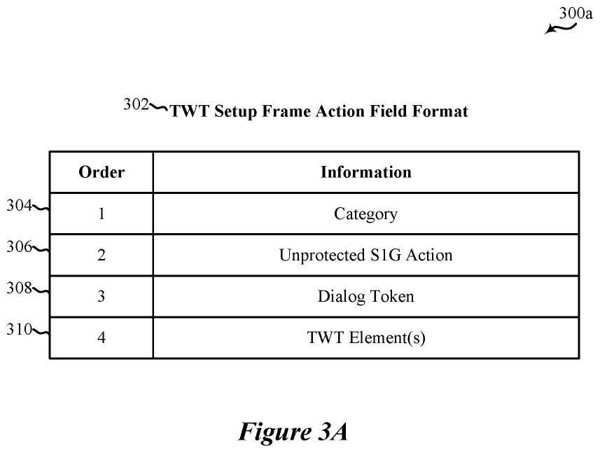

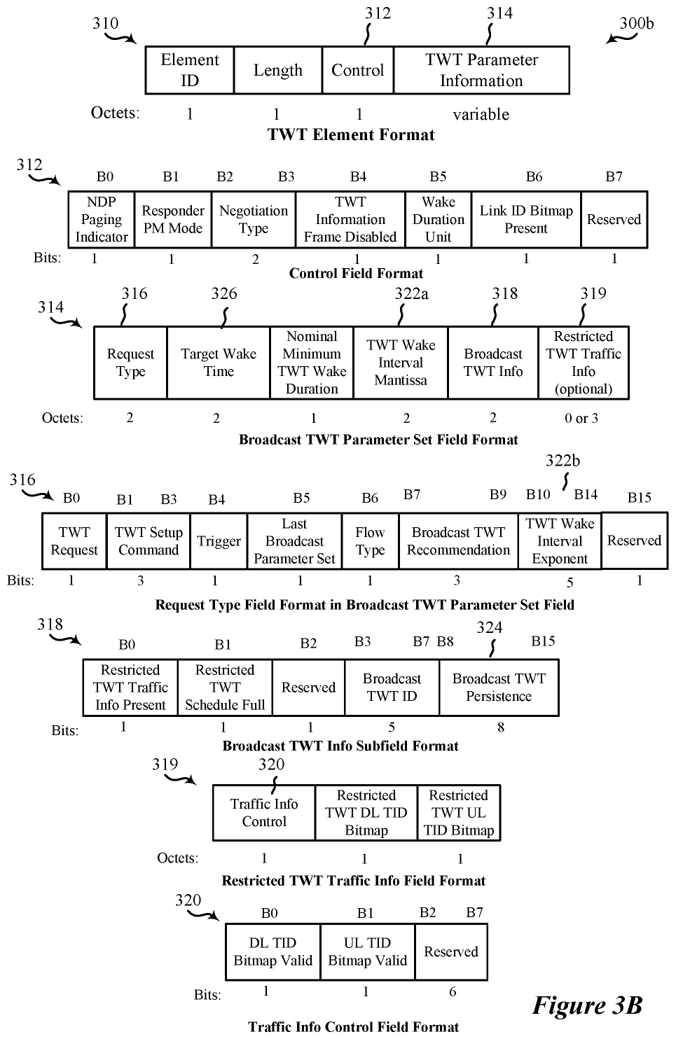

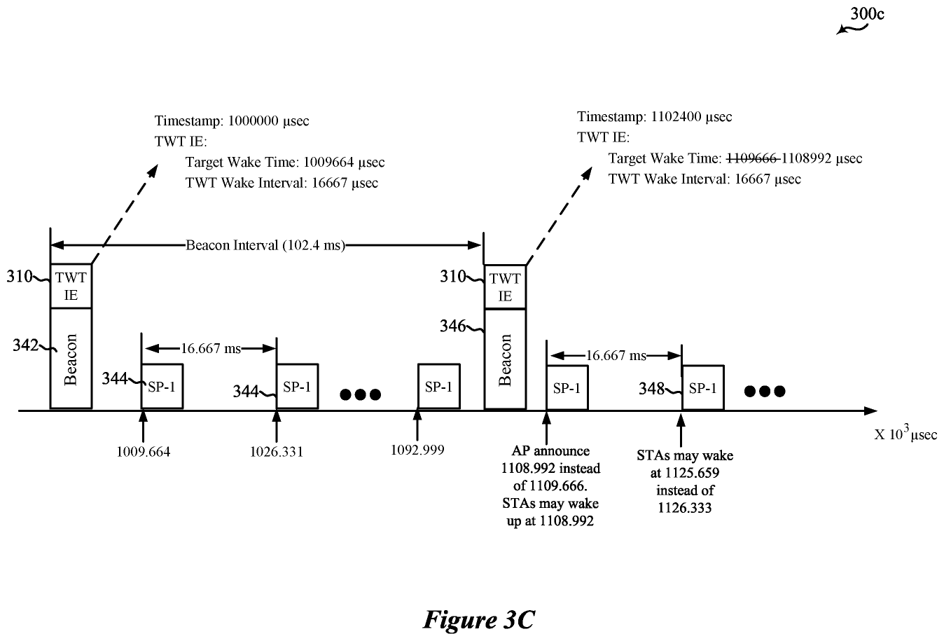

Referring now to example 300a of FIG. 3A, a STA may send a TWT setup frame 302 to request the setup of a TWT SP. The TWT setup frame may be sent by a responding STA to indicate the status of a requested TWT SP. The Action field of the TWT setup frame may contain various information or fields, including a category 304, an unprotected S1G action 306, a dialog token 308, and one or more TWT elements 310. In some implementations, the STA may configure optional field(s) or optional element(s) in the TWT setup frame 302 or TWT element(s) 310, such as R-TWT traffic information.

Referring now to example 300b of FIG. 3B, TWT element 310 may include various fields and sub-fields such as illustrated. For example, TWT element 310 may include an element ID, a length, a control field 312, and TWT parameter information 314. The TWT parameter information 314 may include various fields or sub-fields as illustrated, including at least a request type 316, broadcast TWT information 318, restricted TWT traffic information 319, traffic information control 320, a TWT wake interval 322a, 322b, a broadcast-TWT persistence field 324, and a target wake time 326.

Referring now to example 300c of FIG. 3C, a wireless communication device (e.g., AP) may send TWT element 310 in a beacon frame 342. The TWT element may indicate the target wake time 326 (e.g., 1009664 microseconds) and TWT wake interval 322a, 322b (e.g., 16667 microseconds) in the TWT parameter set of the TWT element transmitted in the beacon frame. The second wireless communication device (e.g., STA) may communicate in TWT SPs 344 which may occur periodically after this beacon frame 342 a configured number of times at TWT wake intervals 322a, 322b (in this example 16.667 ms). Afterwards, the wireless communication device (e.g., the AP) may send a subsequent TWT element (e.g., TWT element 310) in another beacon frame 346. Conventionally, this subsequent TWT element may indicate a different target wake time (e.g., 1109666 microseconds) and the TWT wake interval 322a, 322b (e.g., 16667 microseconds). Similarly, TWT SPs 348 may occur periodically a configured number of times after this beacon frame 346 at the TWT wake intervals.

However, this technique for communicating the target wake time field does not allow for indicating target wake times that are not multiples of an interval threshold. For example, this technique does not allow for TWT wake intervals 322a, 322b to be indicated when the target wake time 326 is not a multiple of 1024 microseconds because the TWT element in the TWT setup and beacon frames may not carry a resolution less than 1024 microseconds. Therefore, for certain types of traffic (e.g., XR traffic) the second wireless communication device (e.g., STA) may have traffic at frequency which may not be a multiple of 1024 microseconds. For example, as shown in FIG. 3C, beacon frame 346 may indicate a truncated TWT of 1108992 microseconds to fit its TWT resolution. Thus, the second wireless communication device may wake or transition into an active mode, at times when it does not have to communicate any data, or the device may wake or transition into the active mode earlier than needed to successfully communicate the data, which wastes power and increases power consumption. In some cases, the second wireless communication device may also end the transmission opportunity (TXOP) before the start of the TWT SP (e.g., R-TWT SP or Coordinated (R)-TWT SP) and hence this may delay the delivery of latency sensitive traffic of the members of the TWT SP.

Accordingly, to improve its power consumption and latency performance, in some implementations, a first wireless communication device (e.g., AP) may transmit, to a second wireless communication device (e.g., STA), the TWT element such that the TWT element 310 always indicates a TWT start time of an initial TWT SP in a TWT schedule on a link between the first wireless communication device and the second wireless communication device (e.g., AP, STA, and the like). For example, in the beacon frame 346 as well as beacon frame 342, the TWT element 310 may be configured to indicate the original TWT start time corresponding to the very first SP of the TWT schedule as a timestamp synchronization function (TSF) based time (e.g., 1009664 microseconds in this example). While FIG. 3C shows the TWT element 310 being transmitted in beacon frame 342, in other examples, the TWT element may be transmitted in a different TWT frame (e.g., TWT information frame 202, TWT setup frame, or a beacon frame). The TWT element may be configured to always indicate the TWT start time of the initial TWT SP in the TWT schedule. In some cases, the TWT parameter set field(s) in the TWT schedule may indicate a status of the TWT schedule. In some scenarios the status of the schedule may be either idle or active. When the status is idle, STAs involved in the TWT schedule are expected to have different behaviors (e.g., not ending a TXOP in case of R-TWT). A change of the status of the TWT schedule, which is announced in the TWT element in the beacon frame, may be considered a critical update. To signal this critical update, for example, the BSS parameter change count field associated with the link may be incremented. In addition, a critical updates flag subfield in the capability information field may be set to 1. This allows the devices to recognize and respond to the critical update.

The second wireless communication device (e.g., STA, the wireless communication device that receives the TWT element) may be configured to compute the future TWT SPs based on the indicated original TWT start time, along with the TWT wake interval and B-TWT persistence field indicated in the TWT element 310. For instance, the second wireless communication device may compute a start time of one or more TWT SPs that are upcoming or subsequent TWT SPs (e.g., TWT SPs 348) based on the TWT start time of the initial TWT SP in the TWT schedule and the TWT wake interval. In some implementations, first wireless communication device (e.g., AP) may continue announcing the start time of the initial TWT SP, where the schedule may be considered valid or active based on the broadcast TWT persistence field transmitted in the TWT element. The second wireless communication device (e.g., STA) may compute start time(s) of upcoming TWT SP(s) in the TWT schedule based on the start time of the initial TWT start time and corresponding TWT wake interval with respect to the current TSF. In some implementations, the second wireless communication device may compute a start time of an upcoming TWT SP using the following formula:

Next_TWT=Current_TSF−mod(Current_TSF-Initial_TWT,TWT_Wake_Interval)+TWT_Wake_Interval

where Next_TWT is a start time of an upcoming TWT SP, Current_TSF is the current TSF value, Initial_TWT is the start time of the initial TWT SP in the schedule, and TWT_Wake_Interval is the configured TWT wake interval.

In some implementations, the TWT element, similar to the optional field(s) 210 or the optional element(s) 211, may indicate one or more links between the first wireless communication device and the second wireless communication device to which the TWT information (e.g., the TWT schedules) may apply. In some implementations, the TWT element may similarly indicate suspension or resumption of one or more TWT schedule(s) on one or more links between the first wireless communication device and the second wireless communication device. In some implementations, the TWT element, similar to the optional field(s) 210 or the optional element(s) 211, may indicate early termination of one or more TWT SPs scheduled on one or more links between the first wireless communication device and the second wireless communication device.

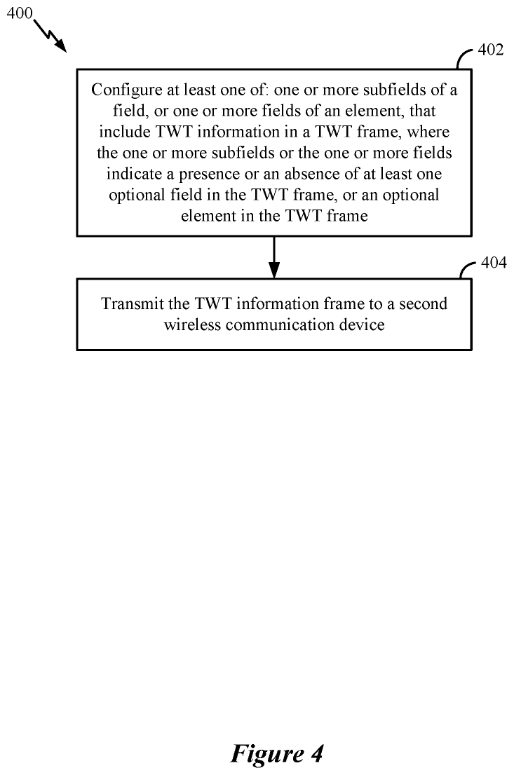

FIG. 4 shows a flowchart illustrating an example process 400 performable at a wireless communication device (e.g., AP, STA, and the like) that supports extending TWT frame functionality, operation, and signaling for enhanced low latency and power savings according to some aspects of the present disclosure. The operations of the process 400 may be implemented by a wireless AP or its components as described herein, and/or a wireless STA or its components as described herein. In some examples, the process 400 may be performed by a wireless AP such as one of the APs 102 and/or a wireless STA such as one of the STAs 104 described with reference to FIG. 1.

In some examples, in block 402, a first wireless communication device may configure at least one of: one or more subfields of a field, or one or more fields of an element, that include target wake time (TWT) information in a TWT frame, wherein the one or more subfields or the one or more fields indicate a presence or an absence of at least one optional field in the TWT frame, or an optional element in the TWT frame. One or more components of wireless communication device 600 or 700, or of AP 102 or STA 104, may constitute the means for configuring. In some examples, the at least one optional field may be an additional field or extended field in the TWT frame.

In some examples, in block 404, the first wireless communication device may transmit the TWT frame to a second wireless communication device. One or more components of wireless communication device 600 or 700, or of AP 102 or STA 104, may constitute the means for transmitting.

In some implementations, the optional element is a multi-link operation (MLO) link information element.

In some implementations, the MLO link information element indicates a first link between the first wireless communication device and the second wireless communication device, and the TWT frame indicates a suspension or a resumption of a TWT schedule on the first link or indicates an early termination of a TWT service period (SP) scheduled on the first link.

In some implementations, the MLO link information element comprises a link identifier (ID) bitmap indicating a first link between the first wireless communication device and the second wireless communication device.

In some implementations, the TWT frame is transmitted to the second wireless communication device via a second link between the first wireless communication device and the second wireless communication device, and the TWT information corresponds to the first link indicated in the MLO link information element.

In some implementations, the TWT frame is transmitted via the second link based on the first link having a different characteristic than the second link.

In some implementations, the TWT frame is transmitted to the second wireless communication device via the first link based on the MLO link information element indicating the first link.

In some implementations, the at least one optional field indicates a link identifier (ID), a traffic identifier (TID), a stream classification service identifier (SCSID), or another parameter associated with a TWT schedule, and the at least one optional field is for at least one of a restricted TWT (R-TWT) agreement, an individual TWT (I-TWT) agreement, a broadcast TWT (B-TWT) agreement, an off-channel TWT agreement, a coordinated TWT agreement, a coordinated R-TWT agreement, a coordinated I-TWT agreement, a coordinated B-TWT agreement, a coordinated off-channel TWT agreement, or an extended protocol for a TWT agreement, and the at least one optional field is for a single link between the first wireless communication device and the second wireless communication device, or for multiple links respectively between the second wireless communication device and a first multi-link device (MLD) including the first wireless communication device, or for multiple links respectively between the first wireless communication device and a second MLD including the second wireless communication device, or for multiple links respectively between the first MLD and the second MLD, and the first wireless communication device is an access point (AP) or a station (STA), and the second wireless communication device is another AP or another STA.

In some implementations, the at least one optional field indicates a traffic identifier (TID) or a stream classification service identifier (SCSID) associated with a TWT schedule on a first link between the first wireless communication device and the second wireless communication device.

In some implementations, the at least one optional field includes a TID bitmap, and the TID is indicated via the TID bitmap.

In some implementations, the TWT frame is transmitted to the second wireless communication device via a second link between the first wireless communication device and the second wireless communication device.

In some implementations, the at least one optional field indicates a suspension or a resumption of a TWT schedule on a first link between the first wireless communication device and the second wireless communication device, or indicates an early termination of a TWT service period (SP) scheduled on the first link. In some implementations, the suspension or resumption of a TWT schedule or early termination of TWT SP on a second link may happen after a defined period. The defined period may be a minimum duration needed for the wireless communication device to receive and process the request coming through the first link.

In some implementations, the one or more subfields indicating the presence or the absence of the at least one optional field include a response requested subfield or a next TWT request subfield.

In some implementations, the first wireless communication device may transmit a TWT element, the TWT element being configured to always indicate a TWT start time of an initial TWT service period (SP) in a TWT schedule between the first wireless communication device and the second wireless communication device, where the TWT frame is a TWT information frame transmitted during the TWT schedule, and where a start time of one or more subsequent TWT SPs is based on the TWT start time of the initial TWT SP and a TWT wake interval indicated in the TWT element.

In some implementations, the TWT element may be received or transmitted in a TWT setup frame, a TWT information frame, or a beacon frame.

In some implementations, the TWT element may indicate a suspension or resumption of the TWT schedule on a first link between the first wireless communication device and the second wireless communication device, or indicate an early termination of a TWT service period (SP) scheduled on the first link.

In some implementations, the at least one optional field or the optional element includes a link identifier (ID) of the first link.

In some implementations, the at least one optional field or the optional element includes a link identifier (ID) bitmap, and the first link is indicated via the link ID bitmap.

In some implementations, the at least one optional field or the optional element further indicates another suspension or another resumption of another TWT schedule on a second link between the first wireless communication device and the second wireless communication device, or further indicates another early termination of another TWT SP scheduled on the second link, and the second link is indicated via the link ID bitmap.

In some implementations, the at least one optional field or the optional element indicates an end of traffic delivery for one or more traffic identifiers (TIDs) or one or more stream classification service identifiers (SCSIDs) associated with a TWT service period (SP).

In some implementations, the first wireless communication device may receive or transmit a message indicating a termination of the TWT SP prior to a configured end time for the TWT SP based on the at least one optional field indicating the end of traffic delivery for the one or more TIDs or the one or more SCSIDs.

In some implementations, the TWT frame may be transmitted while the first wireless communication device is in a power management mode.

In some implementations, the second wireless communication device may be an access point (AP) or a station (STA), and the first wireless communication device may be another STA or another AP.

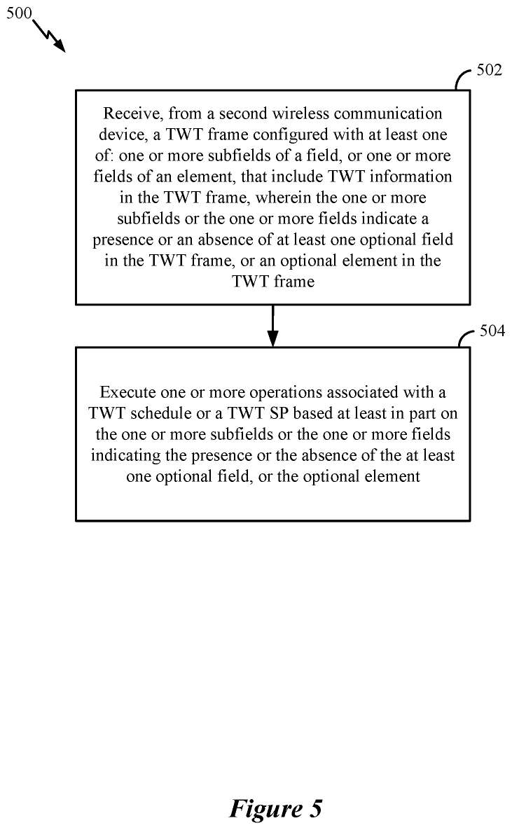

FIG. 5 shows a flowchart illustrating an example process 500 performable at a first wireless communication device (e.g., wireless AP, wireless STA, and the like) that supports extending target wake time (TWT) information frame functionality operation and signaling for enhanced low latency and power savings according to some aspects of the present disclosure. The operations of the process 500 may be implemented by a wireless STA or its components as described herein, and/or by a wireless AP or its components as described herein. In some examples, the process 500 may be performed by a wireless STA such as one of the STAs 104 and/or a wireless AP such as one of the APs 102 described with reference to FIG. 1.

In some examples, in block 502, the first wireless communication device may receive, from a second wireless communication device, a target wake time (TWT) frame configured with at least one of: one or more subfields of a field, or one or more fields of an element, that include TWT information in the TWT frame, wherein the one or more subfields or the one or more fields indicate a presence or an absence of at least one optional field in the TWT frame, or an optional element in the TWT frame. One or more components of wireless communication device 600 or 700, or of AP 102 or STA 104, may constitute the means for receiving. In some examples, the at least one optional field may be an additional field or extended field in the TWT frame.

In some examples, in block 504, the first wireless communication device may execute one or more operations associated with a TWT schedule or a TWT service period (SP) based at least in part on the one or more subfields or the one or more fields indicating the presence or the absence of the at least one optional field, or the optional element. One or more components of wireless communication device 600 or 700, or of AP 102 or STA 104, may constitute the means for executing. In some implementations, at least one operation of the one or more operations is a suspension or a resumption of a TWT schedule on a link between the first wireless communication device and the second wireless communication device, or an early termination of the TWT SP scheduled on the link.

In some examples, a first wireless communication device may receive, from a second wireless communication device, a target wake time (TWT) frame configured with at least one of: one or more subfields of a field, or one or more fields of an element, that include TWT information in the TWT frame, wherein the one or more subfields or the one or more fields indicate a presence or an absence of at least one optional field in the TWT frame, or an optional element in the TWT frame. One or more components of wireless communication device 600 or 700, or of AP 102 or STA 104, may constitute the means for receiving.

In some examples, the first wireless communication device may execute one or more operations associated with a TWT schedule or a TWT service period (SP) based at least in part on the one or more subfields or the one or more fields indicating the presence or the absence of the optional field, or the optional element. One or more components of wireless communication device 600 or 700, or of AP 102 or STA 104, may constitute the means for executing.

In some implementations, the optional element is a multi-link operation (MLO) link information element.

In some implementations, the MLO link information element indicates a first link between the first wireless communication device and the second wireless communication device, and the TWT frame indicates a suspension or a resumption of the TWT schedule on the first link, or an early termination of the TWT SP scheduled on the first link, as the one or more operations.

In some implementations, the MLO link information element includes a link identifier (ID) bitmap indicating a first link between the first wireless communication device and the second wireless communication device.

In some implementations, the TWT frame is received from the second wireless communication device via a second link between the first wireless communication device and the second wireless communication device, and the TWT information corresponds to the first link indicated in the MLO link information element.

In some implementations, the TWT frame is received via the second link based on the first link having a different characteristic than the second link.

In some implementations, the TWT frame is received from the second wireless communication device via the first link based on the MLO link information element indicating the first link.

In some implementations, the at least one optional field indicates a link identifier (ID), a traffic identifier (TID), a stream classification service identifier (SCSID), or another parameter associated with a TWT schedule, and the at least one optional field is for at least one of a restricted TWT (R-TWT) agreement, an individual TWT (I-TWT) agreement, or a broadcast TWT (B-TWT) agreement, an off-channel TWT agreement, a coordinated TWT agreement, a coordinated R-TWT agreement, a coordinated I-TWT agreement, a coordinated B-TWT agreement, a coordinated off-channel TWT agreement, or an extended protocol for a TWT agreement, and the at least one optional field is for a single link between the first wireless communication device and the second wireless communication device, or for multiple links respectively between the second wireless communication device and a first multi-link device (MLD) including the first wireless communication device, or for multiple links respectively between the first wireless communication device and a second MLD including the second wireless communication device, or for multiple links respectively between the first MLD and the second MLD, and the first wireless communication device is an access point (AP) or a station (STA), and the second wireless communication device is another AP or another STA.

In some implementations, the at least one optional field indicates a traffic identifier (TID) or a stream classification service identifier (SCSID) associated with the TWT schedule on a first link between the first wireless communication device and the second wireless communication device.

In some implementations, the at least one optional field includes a TID bitmap, and the TID is indicated via the TID bitmap.

In some implementations, the TWT frame is received from the second wireless communication device via a second link between the first wireless communication device and the second wireless communication device.

In some implementations, the at least one optional field indicates a suspension or a resumption of the TWT schedule on a first link between the first wireless communication device and the second wireless communication device, or an early termination of the TWT SP scheduled on the first link, as the one or more operations.

In some implementations, the one or more subfields indicating the presence or the absence of the at least one optional field include a response requested subfield or a next TWT request subfield.

In some implementations, the first wireless communication device may receive a TWT element, the TWT element being configured to always indicate a TWT start time of an initial TWT service period (SP) in the TWT schedule between the first wireless communication device and the second wireless communication device, where the TWT frame is a TWT information frame received during the TWT schedule, and where a start time of one or more subsequent TWT SPs is based on the TWT start time of the initial TWT SP and a TWT wake interval indicated in the TWT element.

In some implementations, the at least one optional field or the optional element includes a link identifier (ID) of the first link.

In some implementations, the at least one optional field or the optional element includes a link identifier (ID) bitmap, and the first link is indicated via the link ID bitmap.

In some implementations, the at least one optional field or the optional element further indicates another suspension or another resumption of another TWT schedule on a second link between the first wireless communication device and the second wireless communication device, or further indicates another early termination of another TWT SP scheduled on the second link, and the second link is indicated via the link ID bitmap.

In some implementations, the at least one optional field or the optional element indicates an end of traffic delivery for one or more traffic identifiers (TIDs) or one or more stream classification service identifiers (SCSIDs) associated with the TWT SP.

In some implementations, the first wireless communication device may transmit or receive a message indicating a termination of the TWT SP prior to a configured end time for the TWT SP based on the at least one optional field or the optional element indicating the end of traffic delivery for the one or more TIDs or the one or more SCSIDs and on an absence of scheduled traffic from the first wireless communication device to the second wireless communication device.

In some implementations, the TWT information frame may be received while the second wireless communication device is in a power management mode.

In some implementations, the second wireless communication device is an access point (AP) or a station (STA) and the first wireless communication device is another STA or another AP.

Additionally, with reference to both the example processes 400, 500 of FIGS. 4 and 5, in some implementations, the one or more subfields include at least one repurposed bit to indicate the at least one optional field or the optional element in the TWT frame. In some implementations, the at least one optional field is an additional field or fields defined for a TWT information frame in IEEE 802.11ax. In some implementations, the at least one optional field is an additional field that is different than a category field, an unprotected SIG action field, and a TWT information field. In some implementations, the at least one optional field is an extended field of a field defined for a TWT information frame in IEEE 802.11ax. In some implementations, the extended field includes a greater number of bits than the field defined for the TWT information frame in IEEE 802.11ax. In some implementations, the at least one optional field is an extended version of a category field, an unprotected S1G action field, or a TWT information field. In some implementations, the one or more subfields indicate the at least one optional field is included in a TWT information frame. In some implementations, the one or more subfields include at least one of a TWT flow identifier field, a response requested field, a next TWT request field, a next TWT subfield size field, an all TWT field, or a next TWT field. In some other implementations, all these extensions apply to other frames required for the TWT operation (e.g., TWT frames other than TWT information frames).

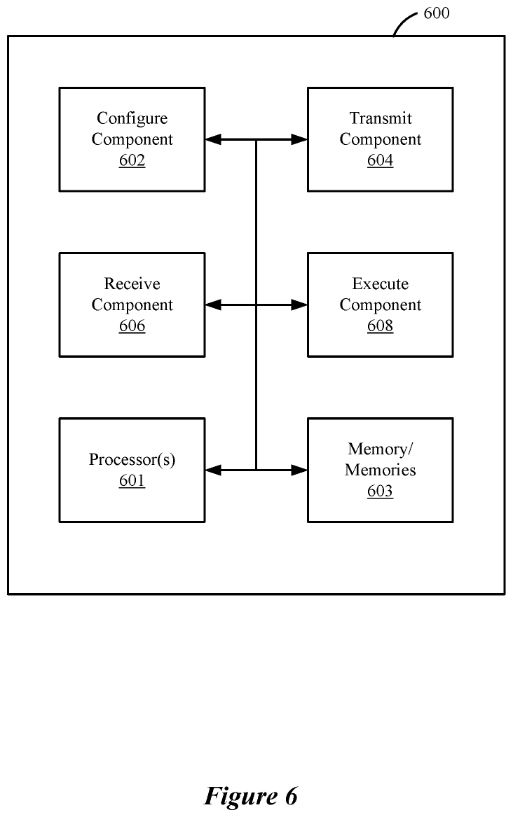

FIG. 6 shows a block diagram of an example wireless communication device 600 that supports extending TWT information frame functionality, operation, and signaling for enhanced low latency and power savings according to some aspects of the present disclosure. In some examples, the wireless communication device 600 is configured or operable to perform the process 400 described with reference to FIG. 4, and/or the process 500 described with reference to FIG. 5. In various examples, the wireless communication device 600 can be a chip, SoC, chipset, package or device that may include: one or more modems (such as a Wi-Fi (IEEE 802.11) modem or a cellular modem such as 3GPP 4G LTE or 5G compliant modem); one or more processors 601, processing blocks or processing elements (collectively “the one or more processors”); one or more radios (collectively “the radio”); and one or more memories 603 or memory blocks (collectively “the one or more memories”).

In some examples, the wireless communication device 600 can be a device for use in an AP, such as AP 102 described with reference to FIG. 1. In some other examples, the wireless communication device 600 can be an AP that includes such a chip, SoC, chipset, package or device as well as multiple antennas. The wireless communication device 600 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 600 also includes or can be coupled with an application processor which may be further coupled with another memory. In some examples, the wireless communication device 600 further includes at least one external network interface that enables communication with a core network or backhaul network to gain access to external networks including the Internet.

The wireless communication device 600 includes a configure component 602, a transmit component 604, a receive component 606, and an execute component 608. Portions of one or more of the components 602, 604, 606, 608 may be implemented at least in part in hardware or firmware. For example, at least some of the components 602, 604, 606, 608 may be implemented at least in part by a modem. In some examples, at least some of the components 602, 604, 606, 608 are implemented at least in part by one or more processors 601 individually or in combination and as software stored in one or more memories 603 individually or in combination. For example, portions of one or more of the components 602, 604, 606, 608 can be implemented as non-transitory instructions (or “code”) executable by the one or more processors 601, individually or in combination, to perform the functions or operations of the respective module.

In some implementations, the one or more processors 601 may be component(s) of a processing system. A processing system may generally refer to a system or series of machines or components that receives inputs and processes the inputs to produce a set of outputs (which may be passed to other systems or components of, for example, the device 600). For example, a processing system of the device 600 may refer to a system including the various other components or subcomponents of the device 600, such as the one or more processors 601, or a transceiver, or a communications manager, or other components or combinations of components of the device 600. The processing system of the device 600 may interface with other components of the device 600, and may process information received from other components (such as inputs or signals) or output information to other components. For example, a chip or modem of the device 600 may include a processing system, a first interface to output information and a second interface to obtain information. In some implementations, the first interface may refer to an interface between the processing system of the chip or modem and a transmitter, such that the device 600 may transmit information output from the chip or modem. In some implementations, the second interface may refer to an interface between the processing system of the chip or modem and a receiver, such that the device 600 may obtain information or signal inputs, and the information may be passed to the processing system. A person having ordinary skill in the art will readily recognize that the first interface also may obtain information or signal inputs, and the second interface also may output information or signal outputs.

The configure component 602 is capable of, configured to, or operable to configure at least one of: one or more subfields of a field, or one or more fields of an element, that include target wake time (TWT) information in a TWT frame, where the one or more subfields or the one or more fields indicate a presence or an absence of at least one optional field in the TWT frame, or an optional element in the TWT frame.

The transmit component 604 is capable of, configured to, or operable to transmit a TWT frame to another wireless communication device. The transmit component 604 is capable of, configured to, or operable to transmit one or more TWT information frames, one or more beacon frames, one or more TWT setup frames, one or more TWT elements, one or more messages, one or more messages indicating termination of one or more TWT SPs, or any combination of the foregoing. In some examples, the transmit component 604 is capable of, configured to, or operable to transmit a TWT element, the TWT element being configured to always indicate a TWT start time of an initial TWT service period (SP) in the TWT schedule between the first wireless communication device and the second wireless communication device, where the TWT frame is a TWT information frame transmitted during the TWT schedule, and where a start time of one or more subsequent TWT SPs is based on the TWT start time of the initial TWT SP and a TWT wake interval indicated in the TWT element.

The receive component 606 is capable of, configured to, or operable to receive a target wake time (TWT) frame configured with at least one of: one or more subfields of a field, or one or more fields of an element, that include TWT information in the TWT frame, where the one or more subfields or the one or more fields indicate a presence or an absence of at least one optional field in the TWT frame, or an optional element in the TWT frame. The receive component 606 is capable of, configured to, or operable to receive one or more TWT information frames, one or more beacon frames, one or more TWT setup frames, one or more TWT elements, one or more messages, one or more messages indicating termination of one or more TWT SPs, or any combination of the foregoing. In some examples, the receive component 606 is capable of, configured to, or operable to receive a TWT element, the TWT element being configured to always indicate a TWT start time of an initial TWT service period (SP) in the TWT schedule between the first wireless communication device and the second wireless communication device, where the TWT frame is a TWT information frame received during the TWT schedule, and where a start time of one or more subsequent TWT SPs is based on the TWT start time of the initial TWT SP and a TWT wake interval indicated in the TWT element.

The execute component 608 is capable of, configured to, or operable to execute one or more operations associated with a TWT schedule or a TWT service period (SP) based at least in part on the one or more subfields or the one or more fields indicating the presence or the absence of the at least one optional field, or the optional element. In some examples, the execute component 608 may include a compute component that is capable of, configured to, or operable to compute a start time of a TWT SP. In some examples, the execute component 608 may include a suspension component that is capable of, configured to, or operable to suspend a TWT schedule. In some examples, the execute component 608 may include a resumption component that is capable of, configured to, or operable to resume a TWT schedule. In some examples, the execute component 608 may include a termination component that is capable of, configured to, or operable to terminate a TWT SP.

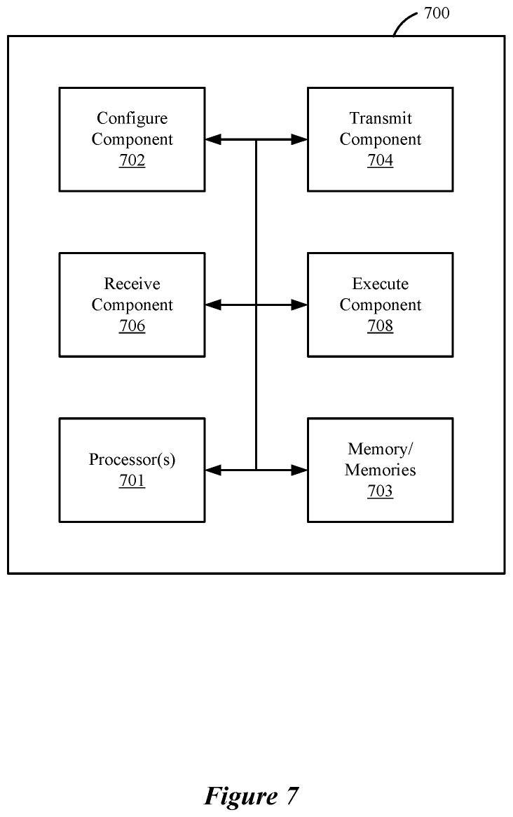

FIG. 7 shows a block diagram of an example wireless communication device 700 that supports extending target wake time (TWT) information frame functionality, operation, and signaling for enhanced low latency and power savings according to some aspects of the present disclosure. In some examples, the wireless communication device 700 is configured or operable to perform the process 500 described with reference to FIG. 5, and/or the process 400 described with reference to FIG. 4. In various examples, the wireless communication device 700 can be a chip, SoC, chipset, package or device that may include: one or more modems (such as, a Wi-Fi (IEEE 802.11) modem or a cellular modem such as 3GPP 4G LTE or 5G compliant modem), one or more processors 701, processing blocks or processing elements (collectively “the one or more processors”); one or more radios (collectively “the radio”); and one or more memories 703 or memory blocks (collectively “the one or more memories”).

In some examples, the wireless communication device 700 can be a device for use in a STA, such as STA 104 described with reference to FIG. 1. In some other examples, the wireless communication device 700 can be a STA that includes such a chip, SoC, chipset, package or device as well as multiple antennas. The wireless communication device 700 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 700 also includes or can be coupled with an application processor which may be further coupled with another memory. In some examples, the wireless communication device 700 further includes a user interface (UI) (such as a touchscreen or keypad) and a display, which may be integrated with the UI to form a touchscreen display. In some examples, the wireless communication device 700 may further include one or more sensors such as, for example, one or more inertial sensors, accelerometers, temperature sensors, pressure sensors, or altitude sensors.

The wireless communication device 700 includes a configure component 702, a transmit component 704, a receive component 706, and an execute component 708. Portions of one or more of the components 702, 704, 706, 708 may be implemented at least in part in hardware or firmware. For example, at least some of the components 702, 704, 706, 708 may be implemented at least in part by a modem. In some examples, at least some of the components 702, 704, 706, 708 are implemented at least in part by one or more processors 701 individually or in combination and as software stored in one or more memories 703 individually or in combination. For example, portions of one or more of the components 702, 704, 706, 708 can be implemented as non-transitory instructions (or “code”) executable by the one or more processors 701, individually or in combination, to perform the functions or operations of the respective module.

In some implementations, the one or more processors 701 may be component(s) of a processing system. A processing system may generally refer to a system or series of machines or components that receives inputs and processes the inputs to produce a set of outputs (which may be passed to other systems or components of, for example, the device 700). For example, a processing system of the device 700 may refer to a system including the various other components or subcomponents of the device 700, such as the one or more processors 701, or a transceiver, or a communications manager, or other components or combinations of components of the device 700. The processing system of the device 700 may interface with other components of the device 700, and may process information received from other components (such as inputs or signals) or output information to other components. For example, a chip or modem of the device 700 may include a processing system, a first interface to output information and a second interface to obtain information. In some implementations, the first interface may refer to an interface between the processing system of the chip or modem and a transmitter, such that the device 700 may transmit information output from the chip or modem. In some implementations, the second interface may refer to an interface between the processing system of the chip or modem and a receiver, such that the device 700 may obtain information or signal inputs, and the information may be passed to the processing system. A person having ordinary skill in the art will readily recognize that the first interface also may obtain information or signal inputs, and the second interface also may output information or signal outputs.

The configure component 702 is capable of, configured to, or operable to configure at least one of: one or more subfields of a field, or one or more fields of an element, that include target wake time (TWT) information in a TWT frame, where the one or more subfields or the one or more fields indicate a presence or an absence of at least one optional field in the TWT frame, or an optional element in the TWT frame.

The transmit component 704 is capable of, configured to, or operable to transmit a TWT frame to another wireless communication device. The transmit component 704 is capable of, configured to, or operable to transmit one or more TWT information frames, one or more beacon frames, one or more TWT setup frames, one or more TWT elements, one or more messages, one or more messages indicating termination of one or more TWT SPs, or any combination of the foregoing. In some examples, the transmit component 704 is capable of, configured to, or operable to transmit a TWT element, the TWT element being configured to always indicate a TWT start time of an initial TWT service period (SP) in the TWT schedule between the first wireless communication device and the second wireless communication device, where the TWT frame is a TWT information frame transmitted during the TWT schedule, and where a start time of one or more subsequent TWT SPs is based on the TWT start time of the initial TWT SP and a TWT wake interval indicated in the TWT element.

The receive component 706 is capable of, configured to, or operable to receive a target wake time (TWT) frame configured with at least one of: one or more subfields of a field, or one or more fields of an element, that include TWT information in the TWT frame, where the one or more subfields or the one or more fields indicate a presence or an absence of at least one optional field in the TWT frame, or an optional element in the TWT frame. The receive component 706 is capable of, configured to, or operable to receive one or more TWT information frames, one or more beacon frames, one or more TWT setup frames, one or more TWT elements, one or more messages, one or more messages indicating termination of one or more TWT SPs, or any combination of the foregoing. In some examples, the receive component 706 is capable of, configured to, or operable to receive a TWT element, the TWT element being configured to always indicate a TWT start time of an initial TWT service period (SP) in the TWT schedule between the first wireless communication device and the second wireless communication device, where the TWT frame is a TWT information frame received during the TWT schedule, and where a start time of one or more subsequent TWT SPs is based on the TWT start time of the initial TWT SP and a TWT wake interval indicated in the TWT element.

The execute component 708 is capable of, configured to, or operable to execute one or more operations associated with a TWT schedule or a TWT service period (SP) based at least in part on the one or more subfields or the one or more fields indicating the presence or the absence of the at least one optional field, or the optional element. In some examples, the execute component 708 may include a compute component that is capable of, configured to, or operable to compute a start time of a TWT SP. In some examples, the execute component 708 may include a suspension component that is capable of, configured to, or operable to suspend a TWT schedule. In some examples, the execute component 708 may include a resumption component that is capable of, configured to, or operable to resume a TWT schedule. In some examples, the execute component 708 may include a termination component that is capable of, configured to, or operable to terminate a TWT SP.

Implementation examples are described in the following numbered clauses:

Clause 1. A first wireless communication device, comprising: one or more memories; one or more processors each communicatively coupled with at least one of the one or more memories, the one or more processors, individually or in combination, configured to cause the first wireless communication device to: configure at least one of: one or more subfields of a field, or one or more fields of an element, that include target wake time (TWT) information in a TWT frame, wherein the one or more subfields or the one or more fields indicate a presence or an absence of at least one optional field in the TWT frame, or an optional element in the TWT frame; and transmit the TWT frame to a second wireless communication device.

Clause 2. The first wireless communication device of clause 1, wherein the optional element is a multi-link operation (MLO) link information element.

Clause 3. The first wireless communication device of clause 2, wherein the MLO link information element indicates a first link between the first wireless communication device and the second wireless communication device, and the TWT frame indicates a suspension or a resumption of a TWT schedule on the first link or indicates an early termination of a TWT service period (SP) scheduled on the first link.

Clause 4. The first wireless communication device of clause 2 or clause 3, wherein the MLO link information element comprises a link identifier (ID) bitmap indicating a first link between the first wireless communication device and the second wireless communication device.

Clause 5. The first wireless communication device of clause 4, wherein the TWT frame is transmitted to the second wireless communication device via a second link between the first wireless communication device and the second wireless communication device, and the TWT information corresponds to the first link indicated in the MLO link information element.

Clause 6. The first wireless communication device of clause 5, wherein the TWT frame is transmitted via the second link based on the first link having a different characteristic than the second link.

Clause 7. The first wireless communication device of clause 4, wherein the TWT frame is transmitted to the second wireless communication device via the first link based on the MLO link information element indicating the first link.

Clause 8. The first wireless communication device of any of clauses 1 to 7, wherein the at least one optional field indicates a suspension or a resumption of a TWT schedule on a first link between the first wireless communication device and the second wireless communication device, or indicates an early termination of a TWT service period (SP) scheduled on the first link.

Clause 9. The first wireless communication device of any of clauses 1 to 8, wherein the one or more processors, individually or in combination, are further configured to cause the first wireless communication device to: transmit a TWT element, the TWT element being configured to always indicate a TWT start time of an initial TWT service period (SP) in a TWT schedule between the first wireless communication device and the second wireless communication device, wherein the TWT frame is a TWT information frame transmitted during the TWT schedule, and wherein a start time of one or more subsequent TWT SPs is based on the TWT start time of the initial TWT SP and a TWT wake interval indicated in the TWT element.

Clause 10. A first wireless communication device, comprising: one or more memories; one or more processors each communicatively coupled with at least one of the one or more memories, the one or more processors, individually or in combination, configured to cause the first wireless communication device to: receive, from a second wireless communication device, a target wake time (TWT) frame configured with at least one of: one or more subfields of a field, or one or more fields of an element, that include TWT information in the TWT frame, wherein the one or more subfields or the one or more fields indicate a presence or an absence of at least one optional field in the TWT frame, or an optional element in the TWT frame; and execute one or more operations associated with a TWT schedule or a TWT service period (SP) based at least in part on the one or more subfields or the one or more fields indicating the presence or the absence of the at least one optional field, or the optional element.

Clause 11. The first wireless communication device of clause 10, wherein the optional element is a multi-link operation (MLO) link information element.

Clause 12. The first wireless communication device of clause 11, wherein the MLO link information element indicates a first link between the first wireless communication device and the second wireless communication device, and the TWT frame indicates a suspension or a resumption of the TWT schedule on the first link, or an early termination of the TWT SP scheduled on the first link, as the one or more operations.

Clause 13. The first wireless communication device of clause 11 or clause 12, wherein the MLO link information element includes a link identifier (ID) bitmap indicating a first link between the first wireless communication device and the second wireless communication device.

Clause 14. The first wireless communication device of clause 13, wherein the TWT frame is received from the second wireless communication device via a second link between the first wireless communication device and the second wireless communication device, and the TWT information corresponds to the first link indicated in the MLO link information element.

Clause 15. The first wireless communication device of clause 14, wherein the TWT frame is received via the second link based on the first link having a different characteristic than the second link.

Clause 16. The first wireless communication device of clause 13, wherein the TWT frame is received from the second wireless communication device via the first link based on the MLO link information element indicating the first link.

Clause 17. The first wireless communication device of any of clauses 10 to 16, wherein the at least one optional field indicates a traffic identifier (TID) or a stream classification service identifier (SCSID) associated with the TWT schedule on a first link between the first wireless communication device and the second wireless communication device.

Clause 18. The first wireless communication device of clause 17, wherein the at least one optional field includes a TID bitmap, and the TID is indicated via the TID bitmap.

Clause 19. The first wireless communication device of clause 17 or clause 18, wherein the TWT frame is received from the second wireless communication device via a second link between the first wireless communication device and the second wireless communication device.

Clause 20. The first wireless communication device of any of clauses 17 to 19, wherein the at least one optional field indicates a suspension or a resumption of the TWT schedule on a first link between the first wireless communication device and the second wireless communication device, or an early termination of the TWT SP scheduled on the first link, as the one or more operations.

Clause 21. A method of wireless communication performable at a first wireless communication device, comprising: configuring at least one of: one or more subfields of a field, or one or more fields of an element, that include target wake time (TWT) information in a TWT frame, wherein the one or more subfields or the one or more fields indicate a presence or an absence of at least one optional field in the TWT frame, or an optional element in the TWT frame; and transmitting the TWT frame to a second wireless communication device.

Clause 22. The method of clause 21, wherein the at least one optional field indicates a link identifier (ID), a traffic identifier (TID), a stream classification service identifier (SCSID), or another parameter associated with a TWT schedule, and wherein the at least one optional field is for at least one of a restricted TWT (R-TWT) agreement, an individual TWT (I-TWT) agreement, a broadcast TWT (B-TWT) agreement, an off-channel TWT agreement, a coordinated TWT agreement, a coordinated R-TWT agreement, a coordinated I-TWT agreement, a coordinated B-TWT agreement, a coordinated off-channel TWT agreement, or an extended protocol for a TWT agreement, and wherein the at least one optional field is for a single link between the first wireless communication device and the second wireless communication device, or for multiple links respectively between the second wireless communication device and a first multi-link device (MLD) including the first wireless communication device, or for multiple links respectively between the first wireless communication device and a second MLD including the second wireless communication device, or for multiple links respectively between the first MLD and the second MLD, and wherein the first wireless communication device is an access point (AP) or a station (STA), and the second wireless communication device is another AP or another STA.

Clause 23. The method of clause 21 or clause 22, wherein the at least one optional field indicates a traffic identifier (TID) or a stream classification service identifier (SCSID) associated with a TWT schedule on a first link between the first wireless communication device and the second wireless communication device.

Clause 24. The method of clause 23, wherein the at least one optional field includes a TID bitmap, and the TID is indicated via the TID bitmap.

Clause 25. The method of clause 23 or clause 24, wherein the TWT frame is transmitted to the second wireless communication device via a second link between the first wireless communication device and the second wireless communication device.

Clause 26. The method of any of clauses 21 to 25, wherein the one or more subfields indicating the presence or the absence of the at least one optional field include a response requested subfield or a next TWT request subfield.

Clause 27. A method of wireless communication performable at a first wireless communication device, comprising: receiving, from a second wireless communication device, a target wake time (TWT) frame configured with at least one of: one or more subfields of a field, or one or more fields of an element, that include TWT information in the TWT frame, wherein the one or more subfields or the one or more fields indicate a presence or an absence of at least one optional field in the TWT frame, or an optional element in the TWT frame; and executing one or more operations associated with a TWT schedule or a TWT service period (SP) based at least in part on the one or more subfields or the one or more fields indicating the presence or the absence of the at least one optional field, or the optional element.

Clause 28. The method of clause 27, wherein the at least one optional field indicates a link identifier (ID), a traffic identifier (TID), a stream classification service identifier (SCSID), or another parameter associated with a TWT schedule, and wherein the at least one optional field is for at least one of a restricted TWT (R-TWT) agreement, an individual TWT (I-TWT) agreement, or a broadcast TWT (B-TWT) agreement, an off-channel TWT agreement, a coordinated TWT agreement, a coordinated R-TWT agreement, a coordinated I-TWT agreement, a coordinated B-TWT agreement, a coordinated off-channel TWT agreement, or an extended protocol for a TWT agreement, and wherein the at least one optional field is for a single link between the first wireless communication device and the second wireless communication device, or for multiple links respectively between the second wireless communication device and a first multi-link device (MLD) including the first wireless communication device, or for multiple links respectively between the first wireless communication device and a second MLD including the second wireless communication device, or for multiple links respectively between the first MLD and the second MLD, and wherein the first wireless communication device is an access point (AP) or a station (STA), and the second wireless communication device is another AP or another STA.

Clause 29. The method of clause 27 or clause 28, wherein the one or more subfields indicating the presence or the absence of the at least one optional field include a response requested subfield or a next TWT request subfield.

Clause 30. The method of any of clauses 27 to 29, further comprising: receiving a TWT element, the TWT element being configured to always indicate a TWT start time of an initial TWT service period (SP) in the TWT schedule between the first wireless communication device and the second wireless communication device, wherein the TWT frame is a TWT information frame received during the TWT schedule, and

wherein a start time of one or more subsequent TWT SPs is based on the TWT start time of the initial TWT SP and a TWT wake interval indicated in the TWT element.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,”’ or the equivalent in context, whatever it is that is “based on ‘a,’” or “based at least in part on ‘a,”’ may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
one or more memories;
one or more processors each communicatively coupled with at least one of the one or more memories, the one or more processors, individually or in combination, configured to cause the first wireless communication device to:
configure at least one of:
one or more subfields of a field, or one or more fields of an element, that include target wake time (TWT) information in a TWT frame, wherein the one or more subfields or the one or more fields indicate a presence or an absence of at least one optional field in the TWT frame, or
an optional element in the TWT frame; and
transmit the TWT frame to a second wireless communication device.

2. The first wireless communication device of claim 1, wherein the optional element is a multi-link operation (MLO) link information element.

3. The first wireless communication device of claim 2, wherein the MLO link information element indicates a first link between the first wireless communication device and the second wireless communication device, and the TWT frame indicates a suspension or a resumption of a TWT schedule on the first link or indicates an early termination of a TWT service period (SP) scheduled on the first link.

4. The first wireless communication device of claim 2, wherein the MLO link information element comprises a link identifier (ID) bitmap indicating a first link between the first wireless communication device and the second wireless communication device.

5. The first wireless communication device of claim 4, wherein the TWT frame is transmitted to the second wireless communication device via a second link between the first wireless communication device and the second wireless communication device, and the TWT information corresponds to the first link indicated in the MLO link information element.

6. The first wireless communication device of claim 5, wherein the TWT frame is transmitted via the second link based on the first link having a different characteristic than the second link.

7. The first wireless communication device of claim 4, wherein the TWT frame is transmitted to the second wireless communication device via the first link based on the MLO link information element indicating the first link.

8. The first wireless communication device of claim 1, wherein the at least one optional field indicates a suspension or a resumption of a TWT schedule on a first link between the first wireless communication device and the second wireless communication device, or indicates an early termination of a TWT service period (SP) scheduled on the first link.

9. The first wireless communication device of claim 1, wherein the one or more processors, individually or in combination, are further configured to cause the first wireless communication device to: transmit a TWT element, the TWT element being configured to always indicate a TWT start time of an initial TWT service period (SP) in a TWT schedule between the first wireless communication device and the second wireless communication device, wherein the TWT frame is a TWT information frame transmitted during the TWT schedule, and
wherein a start time of one or more subsequent TWT SPs is based on the TWT start time of the initial TWT SP and a TWT wake interval indicated in the TWT element.

10. A first wireless communication device, comprising:
one or more memories;
one or more processors each communicatively coupled with at least one of the one or more memories, the one or more processors, individually or in combination, configured to cause the first wireless communication device to:
receive, from a second wireless communication device, a target wake time (TWT) frame configured with at least one of:
one or more subfields of a field, or one or more fields of an element, that include TWT information in the TWT frame, wherein the one or more subfields or the one or more fields indicate a presence or an absence of at least one optional field in the TWT frame, or
an optional element in the TWT frame; and
execute one or more operations associated with a TWT schedule or a TWT service period (SP) based at least in part on the one or more subfields or the one or more fields indicating the presence or the absence of the at least one optional field, or the optional element.

11. The first wireless communication device of claim 10, wherein the optional element is a multi-link operation (MLO) link information element.

12. The first wireless communication device of claim 11, wherein the MLO link information element indicates a first link between the first wireless communication device and the second wireless communication device, and the TWT frame indicates a suspension or a resumption of the TWT schedule on the first link, or an early termination of the TWT SP scheduled on the first link, as the one or more operations.

13. The first wireless communication device of claim 11, wherein the MLO link information element includes a link identifier (ID) bitmap indicating a first link between the first wireless communication device and the second wireless communication device.

14. The first wireless communication device of claim 13, wherein the TWT frame is received from the second wireless communication device via a second link between the first wireless communication device and the second wireless communication device, and the TWT information corresponds to the first link indicated in the MLO link information element.

15. The first wireless communication device of claim 14, wherein the TWT frame is received via the second link based on the first link having a different characteristic than the second link.

16. The first wireless communication device of claim 13, wherein the TWT frame is received from the second wireless communication device via the first link based on the MLO link information element indicating the first link.

17. The first wireless communication device of claim 10, wherein the at least one optional field indicates a traffic identifier (TID) or a stream classification service identifier (SCSID) associated with the TWT schedule on a first link between the first wireless communication device and the second wireless communication device.

18. The first wireless communication device of claim 17, wherein the at least one optional field includes a TID bitmap, and the TID is indicated via the TID bitmap.

19. The first wireless communication device of claim 17, wherein the TWT frame is received from the second wireless communication device via a second link between the first wireless communication device and the second wireless communication device.

20. The first wireless communication device of claim 17, wherein the at least one optional field indicates a suspension or a resumption of the TWT schedule on a first link between the first wireless communication device and the second wireless communication device, or an early termination of the TWT SP scheduled on the first link, as the one or more operations.

21. A method of wireless communication performable at a first wireless communication device, comprising:
configuring at least one of:
one or more subfields of a field, or one or more fields of an element, that include target wake time (TWT) information in a TWT frame, wherein the one or more subfields or the one or more fields indicate a presence or an absence of at least one optional field in the TWT frame, or
an optional element in the TWT frame; and
transmitting the TWT frame to a second wireless communication device.

22. The method of claim 21,
wherein the at least one optional field indicates a link identifier (ID), a traffic identifier (TID), a stream classification service identifier (SCSID), or another parameter associated with a TWT schedule, and
wherein the at least one optional field is for at least one of a restricted TWT (R-TWT) agreement, an individual TWT (I-TWT) agreement, a broadcast TWT (B-TWT) agreement, an off-channel TWT agreement, a coordinated TWT agreement, a coordinated R-TWT agreement, a coordinated I-TWT agreement, a coordinated B-TWT agreement, a coordinated off-channel TWT agreement, or an extended protocol for a TWT agreement, and
wherein the at least one optional field is for a single link between the first wireless communication device and the second wireless communication device, or for multiple links respectively between the second wireless communication device and a first multi-link device (MLD) including the first wireless communication device, or for multiple links respectively between the first wireless communication device and a second MLD including the second wireless communication device, or for multiple links respectively between the first MLD and the second MLD, and
wherein the first wireless communication device is an access point (AP) or a station (STA), and the second wireless communication device is another AP or another STA.

23. The method of claim 21, wherein the at least one optional field indicates a traffic identifier (TID) or a stream classification service identifier (SCSID) associated with a TWT schedule on a first link between the first wireless communication device and the second wireless communication device.

24. The method of claim 23, wherein the at least one optional field includes a TID bitmap, and the TID is indicated via the TID bitmap.

25. The method of claim 23, wherein the TWT frame is transmitted to the second wireless communication device via a second link between the first wireless communication device and the second wireless communication device.

26. The method of claim 21, wherein the one or more subfields indicating the presence or the absence of the at least one optional field include a response requested subfield or a next TWT request subfield.

27. A method of wireless communication performable at a first wireless communication device, comprising:
receiving, from a second wireless communication device, a target wake time (TWT) frame configured with at least one of:
one or more subfields of a field, or one or more fields of an element, that include TWT information in the TWT frame, wherein the one or more subfields or the one or more fields indicate a presence or an absence of at least one optional field in the TWT frame, or
an optional element in the TWT frame; and
executing one or more operations associated with a TWT schedule or a TWT service period (SP) based at least in part on the one or more subfields or the one or more fields indicating the presence or the absence of the at least one optional field, or the optional element.

28. The method of claim 27, wherein the at least one optional field indicates a link identifier (ID), a traffic identifier (TID), a stream classification service identifier (SCSID), or another parameter associated with a TWT schedule, and
wherein the at least one optional field is for at least one of a restricted TWT (R-TWT) agreement, an individual TWT (I-TWT) agreement, or a broadcast TWT (B-TWT) agreement, an off-channel TWT agreement, a coordinated TWT agreement, a coordinated R-TWT agreement, a coordinated I-TWT agreement, a coordinated B-TWT agreement, a coordinated off-channel TWT agreement, or an extended protocol for a TWT agreement, and
wherein the at least one optional field is for a single link between the first wireless communication device and the second wireless communication device, or for multiple links respectively between the second wireless communication device and a first multi-link device (MLD) including the first wireless communication device, or for multiple links respectively between the first wireless communication device and a second MLD including the second wireless communication device, or for multiple links respectively between the first MLD and the second MLD, and
wherein the first wireless communication device is an access point (AP) or a station (STA), and the second wireless communication device is another AP or another STA.

29. The method of claim 27, wherein the one or more subfields indicating the presence or the absence of the at least one optional field include a response requested subfield or a next TWT request subfield.

30. The method of claim 27, further comprising:
receiving a TWT element, the TWT element being configured to always indicate a TWT start time of an initial TWT service period (SP) in the TWT schedule between the first wireless communication device and the second wireless communication device, wherein the TWT frame is a TWT information frame received during the TWT schedule, and
wherein a start time of one or more subsequent TWT SPs is based on the TWT start time of the initial TWT SP and a TWT wake interval indicated in the TWT element.
